(19) United States
(12) Patent Application Publication
(10) Pub. No.: US 2026/0339580 A1
(43) Pub. Date: Oct. 29, 2026

(54) INFORMATION PROCESSING SYSTEM AND NON-TRANSITORY COMPUTER READABLE MEDIUM

(71) Applicant: Fujifilm Business Innovation Corp., Tokyo (JP)

(72) Inventor: Takahiro TOJO, Kanagawa (JP)

(73) Assignee: Fujifilm Business Innovation Corp., Tokyo (JP)

(21) Appl. No.: 19/379,456

(22) Filed: Nov. 4, 2025

(30) Foreign Application Priority Data
Apr. 24, 2025 (JP) 2025-072677

(51) Int. Cl. G06F 3/12

(52) U.S. Cl. CPC G06F 3/1238; G06F 3/1222; G06F 3/1287

(57) ABSTRACT

An information processing system includes a processor configured to: acquire information of a password set for at least one connected image forming apparatus; and when a password is set for an electronic document to be printed, display on a display unit whether the electronic document is printable in the at least one connected image forming apparatus.

### CROSS-REFERENCE TO RELATED APPLICATIONS

This application is based on and claims priority under 35 USC 119 from Japanese Patent Application No. 2025-072677 filed Apr. 24, 2025.

### BACKGROUND

### I. Technical Field

The present disclosure relates to an information processing system and a non-transitory computer readable medium.

### II. Related Art

Japanese Unexamined Patent Application Publication No. 2007-083439 discloses a printer that, when an electronic document protected by a password is received, collates the password with a password preset in the printer in advance, and when a matching password exists as a result of the collation, performs print output.

Japanese Unexamined Patent Application Publication No. 2022-060716 discloses a printing system that, when the output destination of a print job is an external printer, requests approval for the print execution of the print job, and when the output destination of the print job is an in-house printer, transmits the print job to the in-house printer without requesting approval for the print execution of the print job.

### SUMMARY

When an electronic document with password is printed, there are cases where printing is executed when a password entered using dedicated software is correct, and cases where the electronic document with password is printed directly from an image forming apparatus for which a password is set in advance (hereinafter referred to as direct printing).

However, a user cannot recognize whether direct printing can be performed for the electronic document with password until the electronic document with password is transmitted to the image forming apparatus that is to print the electronic document.

Aspects of non-limiting embodiments of the present disclosure relate to providing an information processing system and a non-transitory computer readable medium capable of causing a user to recognize an image forming apparatus capable of direct printing of an electronic document with password before the electronic document with password is transmitted to the image forming apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: acquire information of a password set for at least one connected image forming apparatus; and when a password is set for an electronic document to be printed, display on a display unit whether the electronic document is printable in the at least one connected image forming apparatus.

### BRIEF DESCRIPTION OF THE DRAWINGS

An exemplary embodiment of the present disclosure will be described in detail based on the following figures, wherein:

FIG. 1 is a diagram illustrating a system configuration of an information processing system of an exemplary embodiment of the present disclosure;

FIG. 2 is a block diagram illustrating a hardware configuration of a cloud server in an exemplary embodiment of the present disclosure;

FIG. 3 is a block diagram illustrating a functional configuration of the cloud server in an exemplary embodiment of the present disclosure;

FIG. 4 is a diagram illustrating an example of information of passwords of image forming apparatuses stored in the cloud server;

FIG. 5 is a diagram illustrating an example of an operation in the information processing system;

FIG. 6 is a diagram illustrating an example of a display screen of a terminal device;

FIG. 7 is a diagram illustrating an example of an operation on the display screen of the terminal device;

FIGS. 8A and 8B are diagrams illustrating an example of the display screen of the terminal device;

FIG. 9 is a diagram illustrating a modification of the operation in the information processing system; and

FIG. 10 is a diagram illustrating a modification of the display screen of the terminal device.

### DETAILED DESCRIPTION

Hereinafter, an example of an exemplary embodiment of the present disclosure will be described with reference to the drawings. In the drawings, the same or equivalent components and parts are denoted by the same reference signs. Dimensional ratios in the drawings are exaggerated for convenience of description and may be different from actual ratios.

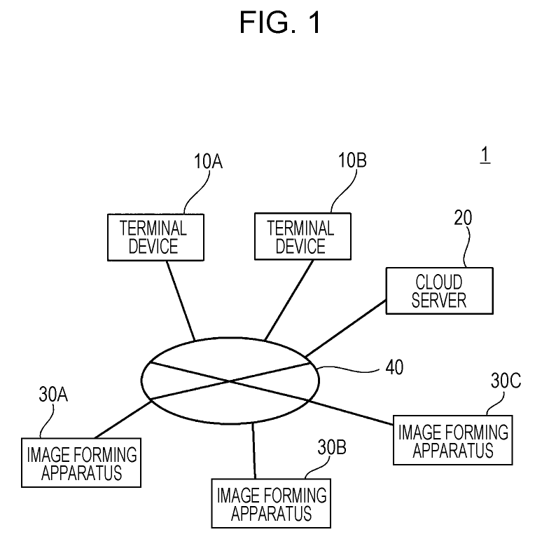

FIG. 1 is a diagram illustrating an example of a schematic configuration of an information processing system 1 according to the present exemplary embodiment. As illustrated in FIG. 1, the information processing system 1 according to the present exemplary embodiment includes terminal devices 10A and 10B, a cloud server 20, and image forming apparatuses 30A, 30B, and 30C. The terminal devices 10A and 10B, the cloud server 20, and the image forming apparatuses 30A, 30B, and 30C are connected to one another via a network 40. As the network 40, for example, a local area network (LAN), a wide area network (WAN), the Internet, or the like is used.

The terminal devices 10A and 10B are information processing devices such as personal computers (PCs) used by users. Each of the terminal devices 10A and 10B creates an electronic document, attaches a password to the electronic document, and transmits the electronic document or the like to the image forming apparatuses 30A, 30B, and 30C or the cloud server 20 via the network 40.

In the present exemplary embodiment, the terminal devices 10A and 10B are configured similarly. Therefore, when the configurations of the terminal devices 10A and 10B are described, both of the terminal devices 10A and 10B are collectively referred to as a terminal device 10 without specifying each device.

The cloud server 20 is an information processing device for storing the electronic document uploaded from the terminal device 10 and transmitting a job of the electronic document for which execution of a printing process is instructed to any of the image forming apparatuses 30A, 30B, and 30C. The cloud server 20 acquires information of passwords set in advance for the image forming apparatuses 30A, 30B, and 30C from the image forming apparatuses 30A, 30B, and 30C, respectively.

The image forming apparatuses 30A, 30B, and 30C receive the electronic document transmitted from the terminal device 10 or the cloud server 20, and output an image corresponding to the electronic document onto a sheet. The image forming apparatuses 30A, 30B, and 30C are apparatuses so-called multifunction peripherals with multiple functions including printing, scanning, copying, facsimile, and post-processing such as stapling and punching.

In the present exemplary embodiment, the image forming apparatuses 30A, 30B, and 30C are configured similarly. Therefore, when the configurations of the image forming apparatuses 30A, 30B, and 30C are described, the image forming apparatuses 30A, 30B, and 30C are collectively referred to as an image forming apparatus 30 without specifying each apparatus.

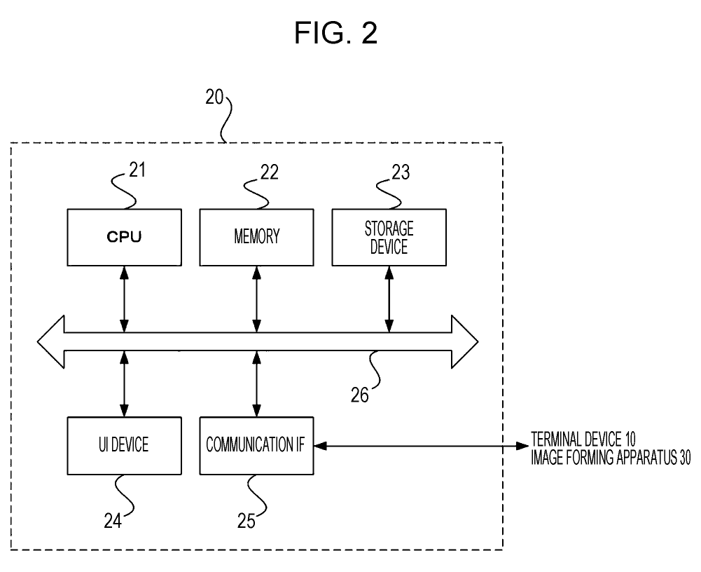

FIG. 2 is a block diagram illustrating a hardware configuration of the cloud server 20 according to the present exemplary embodiment.

As illustrated in FIG. 2, the cloud server 20 includes a central processing unit (CPU) 21, a memory 22 capable of temporarily storing data, a storage device 23 such as a hard disk drive, a user interface (UI) device 24 including a touch panel or a liquid crystal display and a keyboard, and a communication interface (IF) 25 for transmitting and receiving data to and from an external device or the like via the network 40. These components are connected to one another via a control bus 26.

The CPU 21 is a processor that executes a predetermined process based on a control program stored in the memory 22 or the storage device 23 to control the operation of the cloud server 20. In the present exemplary embodiment, the description that the CPU 21 reads and executes a control program stored in the memory 22 or the storage device 23 has been given but the present disclosure is not limited thereto. The control program may be provided in a form recorded on a computer-readable recording medium. For example, the control program may be provided in a form recorded in an optical disc such as a compact disc (CD)-ROM or a digital versatile disc (DVD)-ROM, or in a form recorded in a semiconductor memory such as a Universal Serial Bus (USB) memory and a memory card. The control program may be obtained from an external device through a communication line connected to the communication IF 25. Further, for example, the control program may be provided as standalone application software, or may be integrated into the software of the device as one function of the cloud server 20.

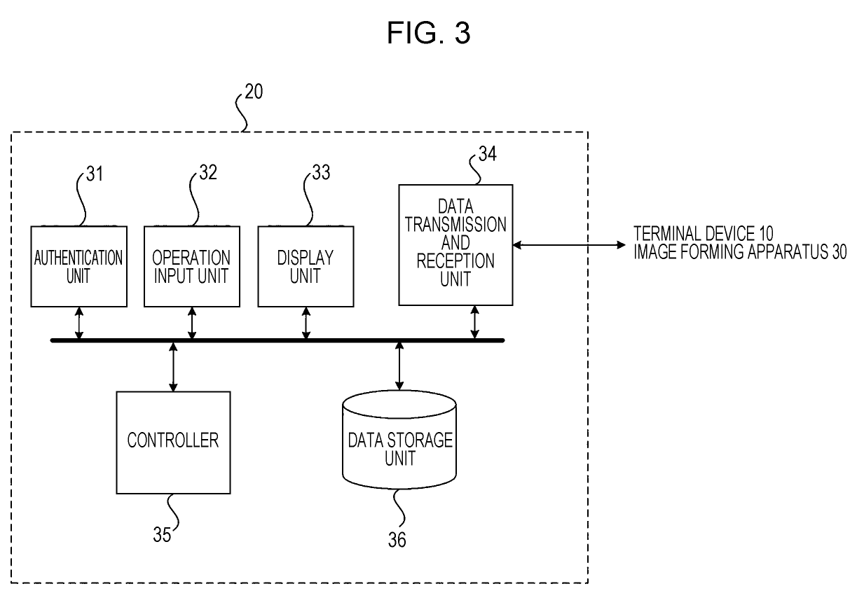

FIG. 3 is a block diagram illustrating a functional configuration of the cloud server 20 realized by execution of the above control program.

As illustrated in FIG. 3, the cloud server 20 of the present exemplary embodiment includes an authentication unit 31, an operation input unit 32, a display unit 33, a data transmission and reception unit 34, a controller 35, and a data storage unit 36.

The data transmission and reception unit 34 transmits and receives data to and from the terminal device 10, the image forming apparatus 30, or the like.

The controller 35 receives an electronic document from the terminal device 10 via the data transmission and reception unit 34. The controller 35 transmits the electronic document to the image forming apparatus 30 via the data transmission and reception unit 34.

The authentication unit 31 executes an authentication process for a user who has made access through the terminal device 10.

The display unit 33 is controlled by the controller 35 to display various kinds of information on the terminal device 10 of the user who performs an operation on the cloud server 20. The operation input unit 32 receives various kinds of operation information on operation performed by the terminal device 10 of the user.

The controller 35 acquires information of a password set for at least one image forming apparatus 30 connected to the terminal device 10 from the at least one image forming apparatus 30 connected to the terminal device 10 via the data transmission and reception unit 34.

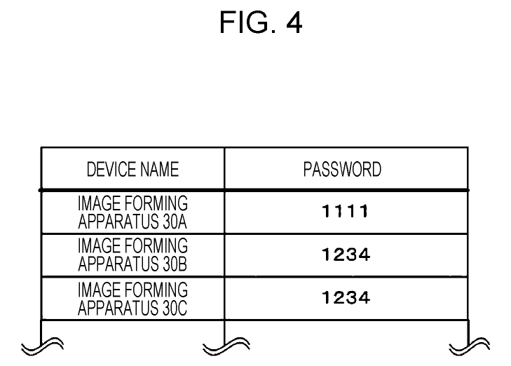

For example, as illustrated in FIG. 4, the data storage unit 36 stores information of passwords set for the image forming apparatuses 30A, 30B, and 30C, which are acquired from the image forming apparatuses 30A, 30B, and 30C connected to the terminal device 10A or 10B. The data storage unit 36 stores various kinds of data such as electronic documents acquired from the terminal device 10A or 10B via the data transmission and reception unit 34.

When an electronic document, which is a job for which a printing process is executed, is selected from the terminal device 10 via the data transmission and reception unit 34, the controller 35 determines whether a password is set for the selected electronic document.

When a password is set for the selected electronic document, the controller 35 displays on the display unit 33 whether the connected image forming apparatus 30 is capable of direct printing of the electronic document for which a password is set.

Specifically, when the password of the electronic document matches any of the passwords acquired from the image forming apparatuses 30A, 30B, and 30C, the controller 35 displays the image forming apparatus 30 with the matching password on the display screen of the terminal device 10 as an image forming apparatus capable of printing the electronic document.

When the password acquired from the image forming apparatus 30 does not match the password of the electronic document, the controller 35 displays the image forming apparatus 30 whose password does not match on the display screen of the terminal device 10 as an image forming apparatus incapable of printing the electronic document.

The controller 35 receives selection of the image forming apparatus 30 that executes the printing process of the electronic document by an operation on the terminal device 10 via the data transmission and reception unit 34.

When the controller 35 receives the selection of the image forming apparatus 30 displayed as an image forming apparatus incapable of printing the electronic document, the controller 35 receives input of the password of the electronic document on the display screen of the terminal device 10. Then, when the input password matches the password of the electronic document, the controller 35 causes the image forming apparatus 30 displayed as an image forming apparatus incapable of printing the electronic document to execute the printing process of the electronic document in a state where the setting of the password is canceled.

The controller 35 changes, on the display screen of the terminal device 10, the information of the password set for the image forming apparatus 30 displayed as an image forming apparatus incapable of printing the electronic document. Specifically, when the controller 35 receives the selection of the image forming apparatus 30 displayed as an image forming apparatus incapable of printing the electronic document, the controller 35 displays a change screen for the information of the password set for the selected image forming apparatus 30 on the display screen of the terminal device 10. Then, the controller 35 changes the information of the password of the selected image forming apparatus 30 based on the information input on the change screen. Then, when the password of the electronic document matches the password newly set for the image forming apparatus 30, the controller 35 changes the display of the image forming apparatus as incapable of printing the electronic document to the display as capable of printing the electronic document.

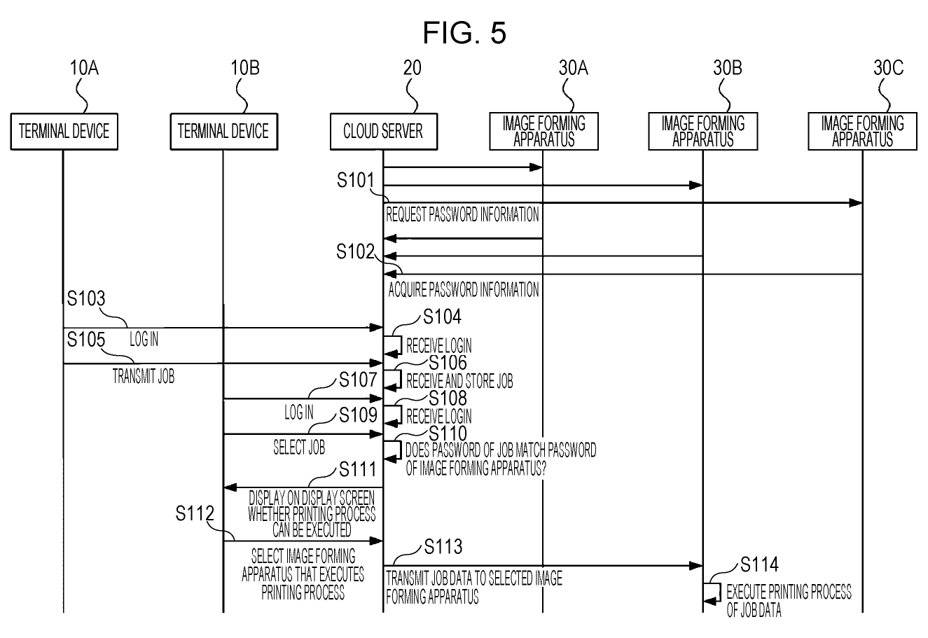

Next, the operation of the information processing system 1 of the present exemplary embodiment will be described with reference to FIG. 5.

In the following description, a user A at home or outside the company stores an electronic document D1 with password in the cloud server 20 using the terminal device 10A. A case will be described in which a user B in the company performs direct printing using the terminal device 10B to directly output the electronic document D1 with password stored in the cloud server 20 by one of the image forming apparatuses 30A to 30C in the company.

First, in step S101, the controller 35 of the cloud server 20 requests the image forming apparatuses 30A, 30B, and 30C connected to the terminal device 10B to provide information of a password set for the respective image forming apparatuses 30A, 30B, and 30C, via the data transmission and reception unit 34.

In step S102, the controller 35 of the cloud server 20 acquires, from the image forming apparatuses 30A, 30B, and 30C connected to the terminal device 10B, the information of a password set for the respective image forming apparatuses 30A, 30B, and 30C, via the data transmission and reception unit 34. Then, the controller 35 of the cloud server 20 stores the acquired password information in the data storage unit 36 in association with apparatus information of the corresponding image forming apparatus 30.

Next, in step S103, the user A operates the terminal device 10A at home or outside the company to log in to the cloud server 20 via the data transmission and reception unit 34.

Next, in step S104, the controller 35 of the cloud server 20 receives the login of the user A by the authentication unit 31 via the data transmission and reception unit 34.

Next, in step S105, the user A operates the terminal device 10A to generate a job of the electronic document D1 with password, which is protected by setting a password, and transmit the job to the cloud server 20.

Next, in step S106, when the controller 35 of the cloud server 20 receives the job of the electronic document D1 with password via the data transmission and reception unit 34, the controller 35 stores the received job in the data storage unit 36.

In step S107, the user B operates the terminal device 10B in the company to log in to the cloud server 20 via the data transmission and reception unit 34.

Next, in step S108, the controller 35 of the cloud server 20 receives the login of the user B by the authentication unit 31 via the data transmission and reception unit 34.

Next, in step S109, the user B operates the terminal device 10B to select a job to execute a printing process from the jobs stored in the data storage unit 36 of the cloud server 20.

Next, in step S110, the controller 35 of the cloud server 20 determines whether a password is set for the selected job (electronic document D1). When a password is not set for the selected job, the job is transmitted to the image forming apparatus 30 selected by the operation of the terminal device 10B from among the image forming apparatuses 30A, 30B, and 30C, which are connected to the terminal device 10B and are capable of printing, and the selected image forming apparatus 30 is caused to execute the printing process of the job. When a password is set for the selected job, the controller 35 of the cloud server 20 determines whether the password of the selected job matches the password set for each of the image forming apparatuses 30A, 30B, and 30C. That is, it is determined whether there is the image forming apparatus 30 of which the password matches the password of the selected job among the image forming apparatuses 30A, 30B, and 30C of which the respective passwords are stored in the data storage unit 36.

That is, the controller 35 of the cloud server 20 acquires, from the image forming apparatuses 30A, 30B, and 30C connected to the terminal device 10B, the information of a password set for the respective image forming apparatuses 30A, 30B, and 30C, regardless of whether a password is set for the selected job (electronic document D1).

Next, in step S111, when a password is set for the selected job, the controller 35 of the cloud server 20 causes the display unit 33 to display, on the display screen of the terminal device 10B, whether the electronic document D1 can be printed by the image forming apparatuses 30A, 30B, and 30C connected to the terminal device 10B. That is, when a password is set for the electronic document D1 to be printed, whether direct printing can be performed for the electronic document D1 by the image forming apparatuses 30A, 30B, and 30C connected to the terminal device 10B is displayed on the display screen of the terminal device 10B.

Specifically, when the password of the electronic document D1 matches any of the passwords acquired from the image forming apparatuses 30A, 30B, and 30C, the controller 35 displays the image forming apparatus 30 with the matching password on the display screen of the terminal device 10B as an image forming apparatus capable of printing the electronic document D1.

When the password acquired from each of the image forming apparatuses 30A, 30B, and 30C does not match the password of the electronic document D1, the controller 35 displays the image forming apparatus 30 whose password does not match on the display screen of the terminal device 10B as an image forming apparatus incapable of printing the electronic document D1.

At this time, on the display screen of the terminal device 10B, the printable image forming apparatuses are displayed differently from the non-printable image forming apparatuses. For example, the controller 35 of the cloud server 20 grays out the display of the non-printable image forming apparatus 30, displays the background color of the display of the non-printable image forming apparatus 30 differently from the background color of the display of the printable image forming apparatus 30, or displays the character color of the display of the non-printable image forming apparatus 30 differently from the character color of the display of the printable image forming apparatus 30.

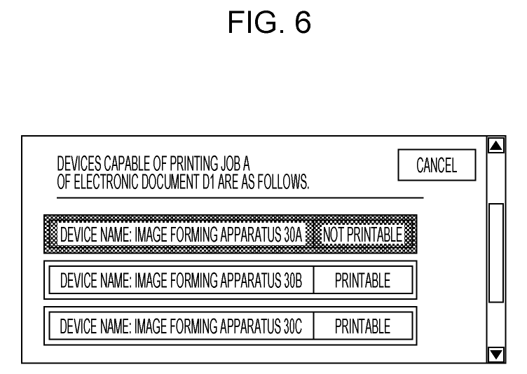

Specifically, as illustrated in FIG. 6, when a password "1234" is set for the electronic document D1, the image forming apparatus 30A for which a password "1111" different from the password of the electronic document D1 is set is displayed on the display screen of the terminal device 10B as not printable. The image forming apparatuses 30B and 30C for which the same password "1234" as the password of the electronic document D1 is set are displayed on the display screen of the terminal device 10B as printable. The display of the non-printable image forming apparatus 30A is grayed out.

That is, the image forming apparatus 30A which cannot execute the printing process of the electronic document D1 and the image forming apparatuses 30B and 30C which can execute the printing process of the electronic document D1 are displayed in a distinguishable manner. Thus, the user can easily recognize the image forming apparatus capable of direct printing of the electronic document D1 with password.

Next, in step S112, the user B selects the image forming apparatus 30B or 30C capable of direct printing from among the image forming apparatuses 30A, 30B, and 30C displayed on the display screen of the terminal device 10B by an operation on the terminal device 10B. Then, the controller 35 of the cloud server 20 receives, via the data transmission and reception unit 34, the selection of the image forming apparatus 30B or 30C that executes the printing process of the electronic document D1 by an operation on the terminal device 10B.

Next, in step S113, the controller 35 of the cloud server 20 transmits the job data to the image forming apparatus 30B selected in step S112 via the data transmission and reception unit 34. At this time, the controller 35 of the cloud server 20 may transmit the job data by encrypted communication using Secure Sockets Layer (SSL), Transport Layer Security (TLS), or the like.

Next, in step S114, the image forming apparatus 30B receives the job data and executes the printing process. That is, the image forming apparatus 30B performs direct printing for the job of the electronic document D1 with password.

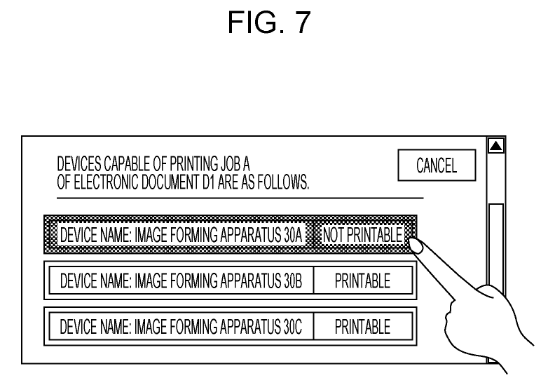

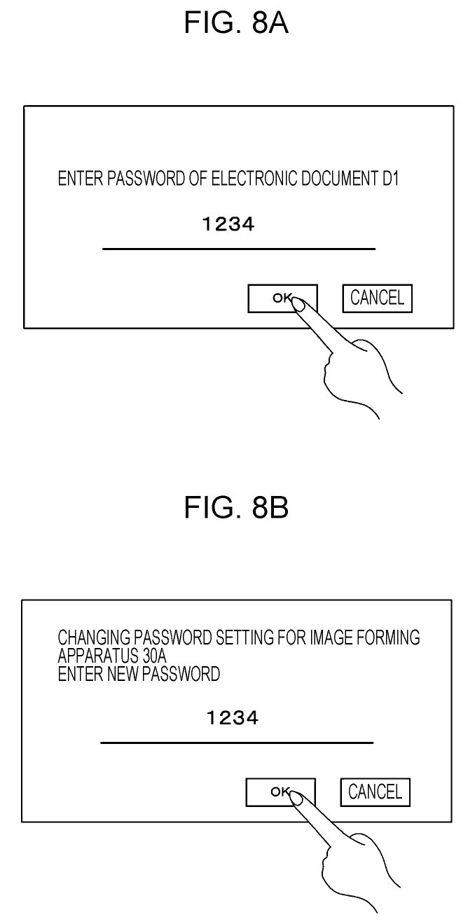

As illustrated in FIGS. 7 and 8A, the user B selects the image forming apparatus 30A displayed on the display screen of the terminal device 10B as not printable, and inputs the password of the electronic document D1 by an operation on the terminal device 10B, whereby the job of the electronic document D1 in a state where the setting of the password is canceled can be printed by the image forming apparatus 30A.

Specifically, when the controller 35 of the cloud server 20 receives the selection of the image forming apparatus 30A displayed as incapable of printing the electronic document D1, the controller 35 receives the input of the password of the electronic document D1 on the display screen of the terminal device 10B. Then, when the input password matches the password of the electronic document D1, the controller 35 of the cloud server 20 causes the image forming apparatus 30A displayed as an image forming apparatus incapable of printing the electronic document D1 to execute the printing process of the electronic document D1 in a state where the setting of the password is canceled.

As illustrated in FIGS. 7 and 8B, the user B selects the image forming apparatus 30A displayed on the display screen of the terminal device 10B as not printable, and registers or changes the setting of the password for the image forming apparatus 30A, whereby direct printing of the job of the electronic document D1 with password can be performed by the image forming apparatus 30A.

That is, the controller 35 of the cloud server 20 can change, on the display screen of the terminal device 10B, the information of the password set for the image forming apparatus 30A displayed as incapable of printing the electronic document D1. Specifically, when the controller 35 of the cloud server 20 receives the selection of the image forming apparatus 30A displayed as incapable of printing the electronic document D1, the controller 35 displays a change screen for the information of the password set for the selected image forming apparatus 30A on the display screen of the terminal device 10B. Then, the controller 35 of the cloud server 20 changes the information of the password of the image forming apparatus 30A based on the information input on the change screen. When the password of the electronic document D1 matches the password newly set for the image forming apparatus 30A, the controller 35 of the cloud server 20 changes the display of the image forming apparatus 30A as incapable of printing the electronic document D1 to the display as capable of printing the electronic document D1. That is, the image forming apparatus 30A can perform direct printing of the electronic document D1.

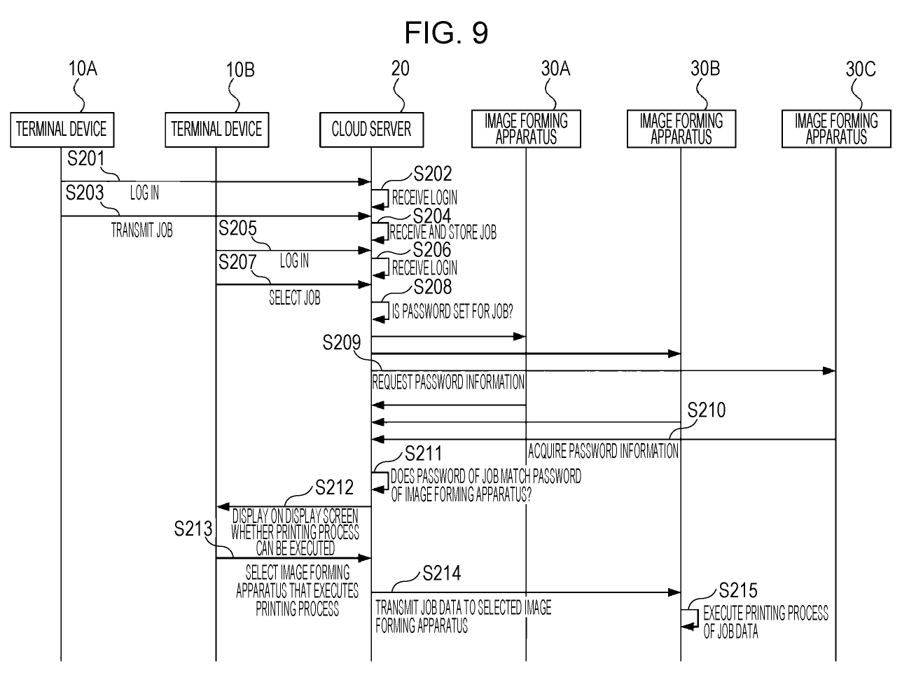

Next, a modification of the operation in the information processing system 1 will be described in detail with reference to FIG. 9.

First, in step S201, the user A operates the terminal device 10A at home or outside the company to log in to the cloud server 20 via the data transmission and reception unit 34.

Next, in step S202, the controller 35 of the cloud server 20 receives the login of the user A by the authentication unit 31 via the data transmission and reception unit 34.

Next, in step S203, the user A operates the terminal device 10A to generate a job of the electronic document D1 with password and transmit the job to the cloud server 20.

Next, in step S204, when the controller 35 of the cloud server 20 receives the job of the electronic document D1 with password via the data transmission and reception unit 34, the controller 35 stores the received job in the data storage unit 36.

Next, in step S205, the user B operates the terminal device 10B in the company to log in to the cloud server 20 via the data transmission and reception unit 34.

Next, in step S206, the controller 35 of the cloud server 20 receives the login of the user B by the authentication unit 31 via the data transmission and reception unit 34.

Next, in step S207, the user B operates the terminal device 10B to select a job to execute a printing process from the jobs stored in the data storage unit 36 of the cloud server 20.

Next, in step S208, the controller 35 of the cloud server 20 determines whether a password is set for the selected job. When a password is not set for the selected job, the job is transmitted to the image forming apparatus 30 selected by the operation of the terminal device 10B from among the image forming apparatuses 30A, 30B, and 30C, which are connected to the terminal device 10B and are capable of printing, and the selected image forming apparatus 30 is caused to execute the printing process of the job.

Next, in step S209, when a password is set for the selected job, the controller 35 of the cloud server 20 requests the image forming apparatuses 30A, 30B, and 30C connected to the terminal device 10B to provide information of a password set for the respective image forming apparatuses 30A, 30B, and 30C, via the data transmission and reception unit 34.

In step S210, the controller 35 of the cloud server 20 acquires, from the image forming apparatuses 30A, 30B, and 30C connected to the terminal device 10B, the information of a password set for each of the respective image forming apparatuses 30A, 30B, and 30C, via the data transmission and reception unit 34. Then, the controller 35 of the cloud server 20 stores the acquired password information in the data storage unit 36 in association with the apparatus information of the corresponding image forming apparatus 30.

That is, in the present modification, the controller 35 of the cloud server 20 acquires, from the image forming apparatuses 30A, 30B, and 30C connected to the terminal device 10B, the information of a password set for the respective image forming apparatuses 30A, 30B, and 30C, when a password is set for the selected job (electronic document D1).

Next, in step S211, when the selected job is the electronic document D1 with password, the controller 35 of the cloud server 20 determines whether the password of the selected job matches the password set for each of the image forming apparatuses 30A, 30B, and 30C. That is, it is determined whether there is the image forming apparatus 30 of which the password matches the password of the selected job among the image forming apparatuses 30A, 30B, and 30C of which the respective passwords are stored in the data storage unit 36.

Next, in step S212, when a password is set for the selected job, the controller 35 of the cloud server 20 causes the display unit 33 to display, on the display screen of the terminal device 10B, whether the electronic document D1 can be printed by the image forming apparatuses 30A, 30B, and 30C connected to the terminal device 10B.

Specifically, when the password of the electronic document D1 matches any of the passwords acquired from the image forming apparatuses 30A, 30B, and 30C, the controller 35 displays the image forming apparatus 30 with the matching password on the display screen of the terminal device 10B as an image forming apparatus capable of printing the electronic document D1.

When the password acquired from each of the image forming apparatuses 30A, 30B, and 30C does not match the password of the electronic document D1, the controller 35 displays the image forming apparatus 30 whose password does not match on the display screen of the terminal device 10B as an image forming apparatus incapable of printing the electronic document D1.

Next, in step S213, the user B selects the image forming apparatus 30B or 30C capable of direct printing from among the image forming apparatuses 30A, 30B, and 30C displayed on the display screen of the terminal device 10B by an operation on the terminal device 10B. Then, the controller 35 of the cloud server 20 receives, via the data transmission and reception unit 34, the selection of the image forming apparatus 30B or 30C that executes the printing process of the electronic document D1 by an operation on the terminal device 10B.

Next, in step S214, the controller 35 of the cloud server 20 transmits the job data to the image forming apparatus 30B selected in step S213 via the data transmission and reception unit 34.

Next, in step S215, the image forming apparatus 30B receives the job data and executes the printing process. That is, the image forming apparatus 30B performs direct printing for the job of the electronic document D1 with password.

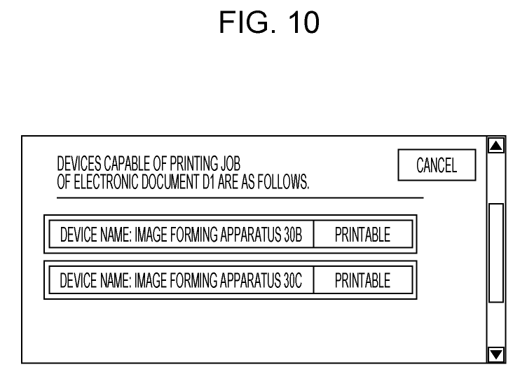

Next, a modification of the display screen of the terminal device 10B will be described with reference to FIG. 10.

In the above exemplary embodiment, a case has been described in which the image forming apparatuses 30B and 30C capable of direct printing of the electronic document D1 and the image forming apparatus 30A incapable of direct printing of the electronic document D1 are displayed on the display screen of the terminal device 10B, among the image forming apparatuses 30A, 30B, and 30C connected to the terminal device 10B. The present disclosure is not limited to this case, and only the image forming apparatuses 30B and 30C capable of direct printing of the electronic document D1 may be displayed on the display screen of the terminal device 10B, among the image forming apparatuses 30A, 30B, and 30C connected to the terminal device 10B.

Specifically, as illustrated in FIG. 10, when the password "1234" is set for the electronic document D1 on the display screen of the terminal device 10B, only the image forming apparatuses 30B and 30C for which the same password "1234" as the password of the electronic document D1 is set may be displayed on the display screen of the terminal device 10B.

That is, the user B can select the image forming apparatus 30B or the image forming apparatus 30C displayed as printable on the display screen of the terminal device 10B, and perform direct printing of the job of the electronic document D1 with password by the selected image forming apparatus 30B or the image forming apparatus 30C.

In the above exemplary embodiment, a case has been described in which the user A stores the electronic document D1 with password in the cloud server 20 and the user B executes the printing process of the job of the electronic document D1 stored in the cloud server 20. The present disclosure is not limited to this case, and the present disclosure can be similarly applied to a case where the user B selects the electronic document D1 stored in the terminal device 10B and executes the printing process without using the cloud server 20.

While an exemplary embodiment of the present disclosure has been described above, the exemplary embodiment of the present disclosure is not limited to the above exemplary embodiment, and various modifications and implementations can be made without departing from the scope of the present disclosure.

In the above exemplary embodiment, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

In the above exemplary embodiment, the processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, in the above exemplary embodiment, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The technique of the present disclosure can also be applied to a program and a program product.

### APPENDIX

(((1)))

An information processing system comprising:
a processor configured to:
acquire information of a password set for at least one connected image forming apparatus; and
when a password is set for an electronic document to be printed, display on a display unit whether the electronic document is printable in the at least one connected image forming apparatus.

(((2)))

The information processing system according to (((1))), wherein when the password represented by the acquired information matches the password of the electronic document, the processor is configured to display the image forming apparatus on the display unit as an image forming apparatus capable of printing the electronic document.

(((3)))

The information processing system according to (((1))) or (((2))), wherein when the password represented by the acquired information does not match the password of the electronic document, the processor is configured to display the image forming apparatus on the display unit as an image forming apparatus incapable of printing the electronic document.

(((4)))

The information processing system according to (((3))), wherein when the image forming apparatus displayed on the display unit as an image forming apparatus incapable of printing the electronic document is selected, the processor is configured to receive input of the password of the electronic document.

(((5)))

The information processing system according to (((4))), wherein when the input password matches the password of the electronic document, the processor is configured to cause the image forming apparatus displayed as an image forming apparatus incapable of printing the electronic document to execute a printing process of the electronic document in a state where a setting of the password is canceled.

(((6)))

The information processing system according to (((3))), wherein the processor is configured to change the information of the password set for the image forming apparatus displayed as an image forming apparatus incapable of printing the electronic document.

(((7)))

The information processing system according to (((6))), wherein when the password of the electronic document matches the password newly set for the image forming apparatus, the processor is configured to change a display of the image forming apparatus as incapable of printing the electronic document to a display as capable of printing the electronic document.

(((8)))

A program causing a computer to execute a process comprising: when a password is set for an electronic document to be printed, displaying on a display unit whether the electronic document is printable in at least one connected image forming apparatus.

What is claimed is:

1. An information processing system comprising:
a processor configured to:
acquire information of a password set for at least one connected image forming apparatus; and
when a password is set for an electronic document to be printed, display on a display unit whether the electronic document is printable in the at least one connected image forming apparatus.

2. The information processing system according to claim 1, wherein
when the password represented by the acquired information matches the password of the electronic document, the processor is configured to display the image forming apparatus on the display unit as an image forming apparatus capable of printing the electronic document.

3. The information processing system according to claim 1, wherein
when the password represented by the acquired information does not match the password of the electronic document, the processor is configured to display the image forming apparatus on the display unit as an image forming apparatus incapable of printing the electronic document.

4. The information processing system according to claim 3, wherein
when the image forming apparatus displayed on the display unit as an image forming apparatus incapable of printing the electronic document is selected, the processor is configured to receive input of the password of the electronic document.

5. The information processing system according to claim 4, wherein
when the input password matches the password of the electronic document, the processor is configured to cause the image forming apparatus displayed as an image forming apparatus incapable of printing the electronic document to execute a printing process of the electronic document in a state where a setting of the password is canceled.

6. The information processing system according to claim 3, wherein
the processor is configured to change the information of the password set for the image forming apparatus displayed as an image forming apparatus incapable of printing the electronic document.

7. The information processing system according to claim 6, wherein
when the password of the electronic document matches the password newly set for the image forming apparatus, the processor is configured to change a display of the image forming apparatus as incapable of printing the electronic document to a display as capable of printing the electronic document.

8. A non-transitory computer readable medium storing a program causing a computer to execute a process comprising:
when a password is set for an electronic document to be printed, displaying on a display unit whether the electronic document is printable in at least one connected image forming apparatus.
